(19) United States
(12) Patent Application Publication
(10) Pub. No.: US 2006/0098035 A1
(43) Pub. Date: May 11, 2006

(54) Inkjet printing method

(76) Inventor: David J. Matz, Chadds Ford, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/265,933

(22) Filed: Nov. 3, 2005

Related U.S. Application Data
(60) Provisional application No. 60/626,754, filed on Nov. 10, 2004.

(51) Int. Cl. B41J 29/38

(52) U.S. Cl. 347/5

(57) ABSTRACT

This invention pertains to an inkjet printing method, more particularly to a method of printing wherein a print interruption occurs in the middle of a job. The inventive method avoids image banding defects that could otherwise occur as a result of print interruption.

### CROSS-REFERENCE TO RELATED APPLICATIONS

This application claims priority under 35 U.S.C. §119 from U.S. Provisional Application Ser. No. 60/626,754 (filed Nov. 10, 2004), the disclosure of which is incorporated by reference herein for all purposes as if fully set forth.

### BACKGROUND OF THE INVENTION

This invention pertains to an inkjet printing method, more particularly to a method of printing wherein a print interruption occurs in the middle of a job. The inventive method avoids image defects that could otherwise occur as a result of print interruption.

Inkjet printing is a non-impact printing process in which droplets of ink are deposited on print media, such as paper, to form the desired image. The droplets are ejected from a printhead in response to electrical signals generated by a microprocessor.

Ink jet printers commonly use a scanning printhead. After the printhead is scanned across the page, the page is incrementally advanced in a direction orthogonal to the scanning axis to position the medium for a subsequent scan. The printed image is composed of a contiguous series of horizontal swaths, which taken together, create the overall image.

Each swath is the height of the array of nozzles on the printhead. More than one scan of the printhead may be made for each swath, and the scans can be interlaced between swaths to smooth out boundaries between swaths and compensate for failed or misdirected nozzles. Interleaving is also used to allow higher printed dpi than the native spacing of the nozzles on the printhead. In other words, a printhead with 90 dpi native spacing can print at 360 dpi, for example, by “microstepping” the media to increase the apparent resolution. This process of using interleaved and interlaced multipass bands of printing is sometimes referred to as “shingling”.

With multi-pass shingled printing, however, a problem called “wait-banding” can result when the time between scans varies. For example, when a series of primary color passes are made to print a particular secondary color, the actual color resulting on the page can vary depending on the time delay between passes. This difference is believed due to the ink drops of a given pass drying to different degrees before the drops of the second pass are deposited. The two contiguous swaths of different colors will be perceived as undesirable banding. This effect is described in U.S. Pat. No. 5,949,450 (the disclosure of which is incorporated by reference herein for all purposes as if fully set forth).

Solutions to wait-banding tend to involve averaging out scan times and avoiding any long delays, such as pen servicing, until the printer is between pages. This approach is possible with desktop printers where print jobs are small. In large format printing, it is often impossible to avoid extended delays in the middle of a print job, and as large work pieces are typically expensive to produce, rejection of a piece for banding defects is unacceptable.

There remains a need for a printing methods and systems that minimize banding.

### SUMMARY OF THE INVENTION

In accordance with one aspect of the present invention, there is provided a method for ink jet printing onto a substrate to reduce banding defects in a printed image, the method comprising the steps of:

(a) providing an ink jet printer that is responsive to digital data signals, the inkjet printer being equipped with a reciprocating printhead;

(b) loading the printer with a substrate to be printed;

(c) loading the printer with an inkjet ink set; and

(d) printing an image with the reciprocating printhead in a multi-pass mode onto the substrate using the inkjet ink set in response to the digital data signals, the printed image having an initial edge and a final edge,

wherein the multi-pass mode printing is intentionally interrupted by an interruption sequence at least one time prior to reaching the final edge of the printed image to result in an incomplete image, wherein:

(i) upon initiation of the interruption sequence, an interim edge is created on the incomplete image, the interim edge being defined by the incomplete image downfield of the interim edge, and substantially unprinted substrate upfield of the interim edge, the incomplete image having substantially full print density;

(ii) upon creation of the interim edge, the printing is interrupted for an interruption interval; and

(iii) upon completion of the interruption interval, the multi-mode printing is resumed at the interim edge.

The present invention also provides an improved method of multipass inkjet printing an image having an initial edge and a final edge, wherein the printing is intentionally interrupted when the image is incomplete, the improvement comprising that the intentional interruption is by an interruption sequence, wherein:

(i) upon initiation of the interruption sequence, an interim edge is created on the incomplete image, the interim edge being defined by the incomplete image downfield of the interim edge, and substantially unprinted substrate upfield of the interim edge, the incomplete image having substantially full print density;

(ii) upon creation of the interim edge, the printing is interrupted for an interruption interval; and

(iii) upon completion of the interruption interval, the multi-mode printing is resumed at the interim edge.

The present invention still further provides an ink jet printing apparatus comprising:

(a) an ink jet printer that is responsive to digital data signals, the inkjet printer being equipped with a reciprocating printhead; and

(b) a computer connected to or integral with the ink jet printer, the computer comprising software that causes generation of the digital data signals, the software comprising a multi-mode printing routine that causes the inkjet printer to print an image onto a substrate with the reciprocating printhead in a multi-pass mode such that the printed image will have an initial edge and a final edge,

wherein the software further comprises an interruption routine that, when activated on an incomplete image prior to the reciprocating printhead reaching the final edge of the printed image, intentionally interrupts the multi-pass mode printing routine by an interruption sequence such that:

(i) upon initiation of the interruption sequence, an interim edge is created on the incomplete image, the interim edge being defined by the incomplete image downfield of the interim edge, and a substantially unprinted substrate upfield of the interim edge, the incomplete image having substantially full print density;

(ii) upon creation of the interim edge, the printing is interrupted for an interruption interval; and

(iii) upon completion of the interruption interval, the multi-pass mode printing is resumed at the interim edge.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### BRIEF DESCRIPTION OF THE DRAWINGS

FIG. 1 depicts a completed image on a printer with a reciprocating printhead

FIG. 2 depicts normal multipass operation where the reciprocating printhead is serviced in mid-print leaving a partially printed swath.

FIG. 3 depicts the inventive method where an interim edge is created prior to servicing the reciprocating printhead mid-print.

### DETAILED DESCRIPTION OF THE PREFERRED EMBODIMENTS

Substrates

The substrate can be any desired substrate such as paper, textile, wetstrength paper, vinyl, polyester film, polyolefin non-woven webs and others. The substrate can be in the form of a single sheet or work piece, or a continuous web.

The inventive method is particularly advantageous for printing on textile substrates, as the printed patterns are often long continuous webs (necessitating service interruptions mid-pattern) which are cut into smaller pieces and fashioned into apparel that is viewed from short distance where banding defects can be very apparent. Textile includes, but is not limited to, woven fabric or cloth of cotton, wool, silk, nylon, polyester and the like. The finished form of the textile includes, but is not limited to, garments, furnishings such as carpets and upholstery, and the like.

Printers

The printer can be any suitable inkjet printer equipped with a reciprocating (or scanning) printhead. The reciprocating printhead scans on a carriage from one side of the substrate to the other, and a printer can have more than one carriage and printhead.

The inventive method is particularly useful for large format printers. Many commercial large format printers are available and are, in general, considered well known to those of ordinary skill in the relevant art.

As indicated above, the inventive method is particularly advantageous for printing on textile substrates. Commercially available large format inkjet printers adapted for printing textile substrates include, for example, the DuPont™ Artistri™ 2020 and 3210 printers (E.I. du Pont de Nemours and Company, Wilmington, Del., USA).

Inks

The printer manufacturers typically offer one or more ink sets for use with each printer. The inks can contain soluble colorant (dye) or dispersed (pigment) colorant and comprise an aqueous or non-aqueous vehicle. Other additives may also be included in the inks. Non-limiting exemplary ink formulations are also disclosed in, for example, U.S. Pat. No. 5,085,698, WO01/94476, WO03/029007 and WO03/076532, as well as commonly owned U.S. application Ser. No. 11/105,258 (filed Apr. 13, 2005, claiming priority from U.S. Provisional Application Ser. No. 60/564,062 (filed Apr. 21, 2004)) and U.S. application Ser. No. 11/148,905 (filed Jun. 9, 2005, claiming priority from U.S. Provisional Application Ser. No. 60/583,235 (filed Jun. 25, 2004)), the disclosures of which are incorporated herein by reference for all purposes as if fully set forth.

Commonly, an ink set is comprised of at least four differently colored inks (typically CYMK). An ink set can also be an “expanded” to include five or more colored inks, for example, CYMK plus any one or all of O (orange), R (red), G (green) and/or B (blue), as well as various strengths of each the inks (for example, full and light strength).

The choice of available inks and ink sets is generally within the skill of one of ordinary skill in the relevant art based on factors including, for example, the type of printer, printheads, substrate, print speed, print durability and other well-known factors.

Print Mode

In normal operation, printing is accomplished in multiple passes (multipass mode). Multipass printing means the printhead passes over the same area of the substrate more than once and the fraction of ink applied per pass is generally, although not necessarily, the reciprocal of the number of passes. In other words, a 4-pass mode would indicate a printhead makes four passes over the same area of the substrate and that a quarter of the required ink is applied per pass. Multipass mode as prescribed by the present invention means at least two passes and can be any number of passes two or more. During the multiple passes, ink drops can be interlaced and/or interleaved, as is well know in the art. For example, a four-pass mode is described in previously incorporated U.S. Pat. No. 5,949,450 (see, e.g., the discussion starting at column 5, line 29).

Although it is possible to print in one pass, this mode of operation is seldom practiced in printers with reciprocating printheads, and single pass mode of operation is outside the scope of this invention.

During printing, ink is applied in response to digital signals to create the desired image on the substrate. The completed image has an initial edge, a final edge and two outer edges (or simply “sides”).

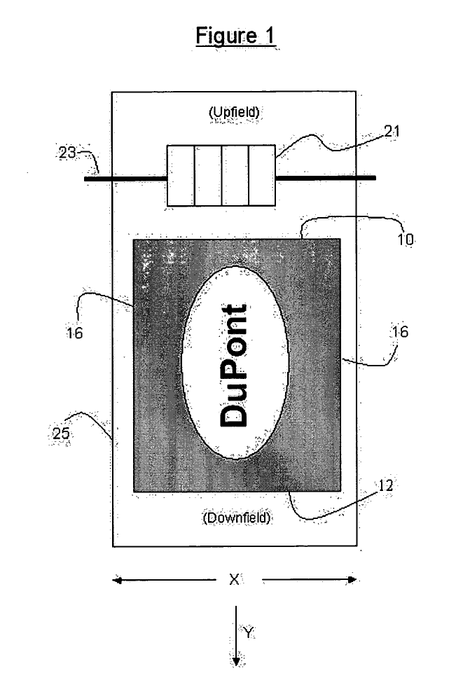

Referring to FIG. 1, there is for exemplification depicted a guide rail 23 upon which a scanning printhead 21 scans in the “X” direction across a substrate 25 fed in the “Y” direction. The printhead 21 as shown is divided into four sections that could represent, for example, individual pens of a typical four-color ink set. The substrate 25 can be a single sheet or, more preferably, a continuous web with the feed and take up rolls (not shown). A completed image bounded by two sides 16, an initial edge 12 and a final edge 10 is shown downfield of the printhead 21.

Print Interruption

A controlled print interruption refers to the intentional interruption of the normal printing operation. The interruption involves the cessation of printing for an interval of time (interruption interval) longer than what is part of normal operation. The interruption interval is not limited to any specific time but is typically at least about 10 seconds, frequently more than about 30 seconds and often more than about one minute.

At the beginning of the print interruption sequence, a print routine is engaged that creates an interim edge prior to the actual cessation of printing during the interruption interval. The “interim edge” refers to a “temporary” edge (or border) in the incomplete image, which is generally a straight edge parallel to the printhead scan direction. The interim edge is sharply defined such that the downfield side (printed side) is substantially completely printed (full print density) and the upfield side (unprinted side) is substantially unprinted.

After the interruption, normal printing is resumed at the interim edge, thereby creating a contiguous image and preferably leaving no visible traces of the interim edge in the final (completed) image.

The print interruption routine is distinct from the situation where normal multipass printing is simply stopped at the end of a printhead scan. Cessation of multipass printing would create a swath of partially printed image (not full print density). The upfield border of the swath would thus not be sharply defined (in the context of the present invention) and most, if not all, of the swath downfield (of the upfield border) would only be partially printed. When printing is resumed under these conditions, visible banding can occur in the region of the partially printed (partial fill) areas. The present invention, in creating the interim edge, fills in what would otherwise be partially filled area so that there is no appearance of a band.

A controlled print interruption can occur for many reasons, including but not limited to printhead maintenance, ink refill, mechanical service and end of the day shut down. In general, controlled print interruption is most prevalent in large-scale print jobs, as most of the reasons for print interruption can be anticipated and handled between prints in small-scale operations.

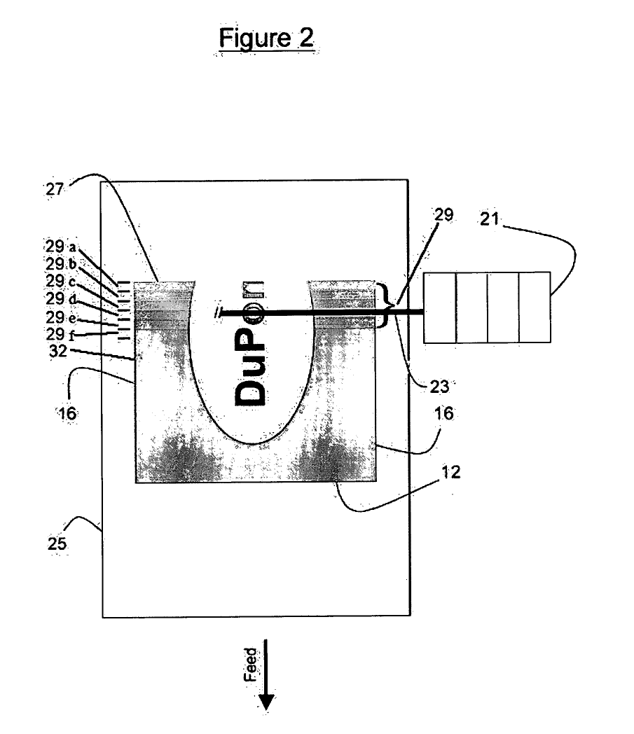

Referring to FIG. 2, there is depicted a typical multipass print interruption during printing of the same image shown completed in FIG. 1. The printhead 21 is shown off to the side as if, for example, at a service station. Reference numbers 12, 16, 23, 25, 27 and 32 are common to, and have the same definition as herein before provided for FIG. 1, except that the carriage 23 was truncated for clarity.

According to normal multipass operation, a swath of partially printed area 29 remains on the substrate during the interruption. As depicted in FIG. 2, printing is performed in 6-pass mode and the swath is divided into six equal sections labeled 29a-29f, with each section one-sixth the width of the full print zone. The multilevel shading of the partially printed swath 29 is intended to show the completeness of each section. Thus, section 29a (the lightest shading) contains one-sixth of the final print density, section 29b contains two-sixths of the final print density and so forth up to 29e, which contains five-sixths the final print density. Section 29f contains 6/6 (100%) of the final print density and is not part of the partially printed area. After the interruption, the unfinished swath is filled as printing resumes.

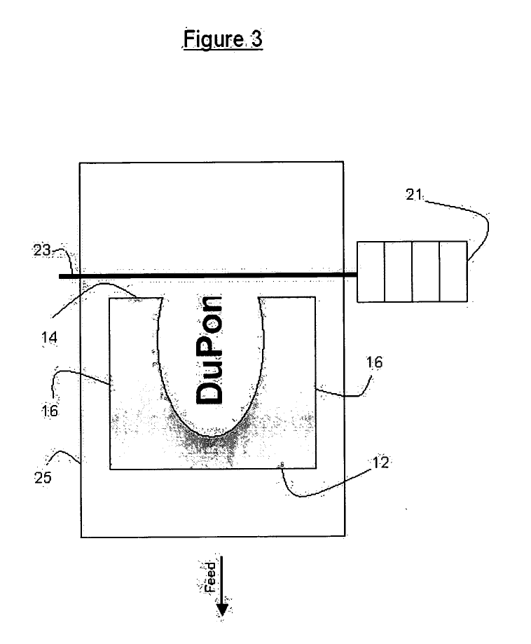

Referring to FIG. 3, there is depicted in accordance with the present invention a print interruption during printing of the same image shown completed in FIG. 1. In this case, and in contrast to normal multipass operation previously depicted in FIG. 2, an interim edge 14 is created according to the inventive method. The printhead 21 is shown off to the side as if, for example, in a service station after completing the interim edge. Reference numbers 12, 16, 23, 25, 27 and 32 are common to, and have the same definition as herein before provided for FIG. 1. After the interruption, printing is resumed precisely at the interim edge 14 so as to create a contiguous image.

Printing Method

The printing method of present invention comprises the step of creating an interim edge prior to a print interruption. The print routine prior to and after the print interruption step can be any desired computer controlled multipass print routine such as those supplied with commercial printers and similar routines. The programming of the specified print interrupt routine into print software is well within the ability of one of ordinary skill in the relevant art. Depending on the particular print routine chosen, the printhead may have to move past the interim edge at the interruption and then back up in order to continue printing. Thus, it can be advantageous for the printer to be able to step the substrate both forward and backward in a controlled manner.

In one aspect, the present invention is an improved method of inkjet printing wherein currently available printers and ink sets and substrates can be employed. Thus, for an improved multipass inkjet printing process wherein printing is interrupted, the improvement comprises the steps of creating an interim edge prior to the interruption of printing, said interim edge being sharply defined with a completely printed downfield side and substantially unprinted upfield side, and after an interruption interval, resuming printing at the interim edge to create a contiguous image.

Additional Preferred Embodiments

As previously indicated, the inventive method is advantageous for large-scale printing, for example continuous images that are at least about 5 feet in length (in the feed, “Y”, direction). Typically, these long continuous images are at least about 2 feet wide, and typically at least about 3 feet wide (in the scanning, “X”, direction).

Textile print patterns are frequently long continuous images, and thus application of the present method in the printing of textiles is advantageous. Textiles are printed with both dye and pigment inks. Banding is observed with both types of inks when printing is interrupted. However, textiles printed with dye inks are typically post treated (e.g. heated, steamed and/or washed) to set the dye and, in the post-treating process, banding defects can sometimes be eliminated or substantially eliminated. Textiles printed with pigment inks, however, are not routinely subjected to rigorous post treatment and the finished textile retains any banding defects. Thus, the inventive printing method is particularly advantageous for printing textile with pigmented inks.

### EXAMPLE

To demonstrate the advantage of the present method, the following test was run. A Dupont™ Artistri™ 2020 printer was equipped with a commercial pigment ink set (available from DuPont), and a solid block of cyan (100% coverage) was printed in the 540 dpi, bidirectional, 12 pass, single carriage mode. In the middle of printing the block of color, a forced interruption of approximately 2.5 minutes in duration was made during which time normal printhead servicing was performed. At the end of the interruption, printing was resumed to complete the color block.

In one test, the printer was run without employing the inventive method (comparative example). At the interruption, printing was simply stopped at the end of a pass. The swath from the last pass contained a band about 2.4 inches wide (equal to 11/12^{ths of the full print swath of the printhead) that was only partially printed. When printing was resumed, the swath was filled in as the remaining portion of the color block was printed. Inspection of the resulting print showed a visible (undesirable) band about} 2.4 inches wide at the point in the print where the interruption occurred.

In another test, demonstrating the invention, the printer was run employing the inventive method. The normal printer software had been modified to allow printing of the interim edge, as this was not part of the standard operating software. At the interruption, an interim edge was created. At the end of the interruption, printing resumed exactly at the interim edge; there were no partial fill areas to complete. Inspection of the resulting print showed (advantageously) substantially no banding in the vicinity of the interruption.

1. A method for ink jet printing onto a substrate, comprising the steps of:
(a) providing an ink jet printer that is responsive to digital data signals, the inkjet printer being equipped with a reciprocating printhead;
(b) loading the printer with a substrate to be printed;
(c) loading the printer with an inkjet ink set; and
(d) printing an image with the reciprocating printhead in a multi-pass mode onto the substrate using the inkjet ink set in response to the digital data signals, the printed image having an initial edge and a final edge,
wherein the multi-pass mode printing is intentionally interrupted by an interruption sequence at least one time prior to reaching the final edge of the printed image to result in an incomplete image, wherein:
(i) upon initiation of the interruption sequence, an interim edge is created on the incomplete image, the interim edge being defined by the incomplete image downfield of the interim edge, and substantially unprinted substrate upfield of the interim edge, the incomplete image having substantially full print density;
(ii) upon creation of the interim edge, the printing is interrupted for an interruption interval; and
(iii) upon completion of the interruption interval, the multi-mode printing is resumed at the interim edge.

2. The method of claim 1, wherein interruption interval is at least about 10 seconds.

3. The method of claim 2, wherein interruption interval is at least about 30 seconds.

4. The method of claim 1, wherein the substrate is textile.

5. The method of claim 1, wherein the substrate is in the form of a continuous web.

6. The method of claim 5, wherein the substrate is textile.

7. The method of claim 6, wherein the printed image is a continuous image at least 5 feet in length from initial edge to final edge.

8. The method of claim 1, wherein the substrate is in the form of a continuous web at least 2 feet wide.

9. The method of claim 1, wherein the printed image is a continuous image at least 5 feet in length from initial edge to final edge.

10. The method of claim 1, wherein the printer is equipped with a pigmented inkjet ink set.

11. An ink jet printing apparatus comprising:
(a) an ink jet printer that is responsive to digital data signals, the inkjet printer being equipped with a reciprocating printhead; and
(b) a computer connected to or integral with the ink jet printer, the computer comprising software that causes generation of the digital data signals, the software comprising a multi-mode printing routine that causes the inkjet printer to print an image onto a substrate with the reciprocating printhead in a multi-pass mode such that the printed image will have an initial edge and a final edge,
wherein the software further comprises an interruption routine that, when activated on an incomplete image prior to the reciprocating printhead reaching the final edge of the printed image, intentionally interrupts the multi-pass mode printing routine by an interruption sequence such that:
(i) upon initiation of the interruption sequence, an interim edge is created on the incomplete image, the interim edge being defined by the incomplete image downfield of the interim edge, and a substantially unprinted substrate upfield of the interim edge, the incomplete image having substantially full print density;
(ii) upon creation of the interim edge, the printing is interrupted for an interruption interval; and
(iii) upon completion of the interruption interval, the multi-pass mode printing is resumed at the interim edge.

12. The printer of claim 11, wherein the printer is further equipped with a substrate and an inkjet ink set.

13. The printer of claim 12, wherein the substrate is textile.

14. The printer of claim 12, wherein the substrate is in the form of a continuous web.

15. The printer of claim 12, wherein the substrate is in the form of a continuous web at least 2 feet wide.

16. The printer of claim 12, wherein the printer is equipped with a pigmented inkjet ink set.
